(19) United States
(12) Patent Application Publication
(10) Pub. No.: US 2004/0208569 A1
(43) Pub. Date: Oct. 21, 2004

(54) System adopting wavelength division multiplexing and method of operating the system

(75) Inventors: Yoshio Nabeyama, Fukuoka (JP); Hiroyuki Iwata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/269,963

(22) Filed: Oct. 15, 2002

(30) Foreign Application Priority Data
Mar. 6, 2002 (JP) 2002-059904

(51) Int. Cl. H04B 10/08; H04J 14/02

(52) U.S. Cl. 398/79

(57) ABSTRACT

Disclosed herein is a system having a first terminal device, a second terminal device, and an optical fiber transmission line for connecting the first and second terminal devices. The first terminal device includes a plurality of optical transmitters for respectively outputting a plurality of optical signals and an optical multiplexer for wavelength division multiplexing the optical signals output from the optical transmitters to obtain WDM signal light. The second terminal device includes an optical demultiplexer for separating the WDM signal light transmitted by the optical fiber transmission line into a plurality of optical signals and a plurality of optical receivers for respectively receiving the optical signals output from the optical demultiplexer. The system includes a device for detecting the abnormality of the temperature of the optical demultiplexer and a device for cutting off the WDM signal light on the upstream side of the optical demultiplexer when the abnormality of the temperature of the optical demultiplexer is detected.

### BACKGROUND OF THE INVENTION

1. Field of the Invention

The present invention relates to a system adopting wavelength division multiplexing and a method of operating the system.

2. Description of the Related Art

In recent years, a manufacturing technique and using technique for a low-loss (e.g., 0.2 dB/km) silica optical fiber have been established, and an optical communication system using the optical fiber as a transmission line has been put to practical use. Further, to compensate for losses in the optical fiber and thereby allow long-haul transmission, the use of an optical amplifier for amplifying an optical signal or signal light has been put to practical use.

An optical amplifier known in the art includes an optical amplifying medium to which signal light to be amplified is supplied and means for pumping the optical amplifying medium so that the optical amplifying medium provides a gain band including the wavelength of the signal light.

For example, an erbium doped fiber amplifier (EDFA) has already been developed to amplify signal light in a 1.55 μm band where the loss in a silica fiber is low. The EDFA includes an erbium doped fiber (EDF) as the optical amplifying medium and a pumping source for supplying pump light having a predetermined wavelength to the EDF. By preliminarily setting the wavelength of the pump light within a 0.98/m band or a 1.48 μm band, a gain band including a wavelength of 1.55 μm can be obtained.

As a technique for increasing a transmission capacity by a single optical fiber, wavelength division multiplexing (WDM) is known. In a system adopting WDM, a plurality of optical carriers having different wavelengths are used. The plural optical carriers are individually modulated to thereby obtain a plurality of optical signals, which are wavelength division multiplexed by an optical multiplexer to obtain WDM signal light, which is output to an optical fiber transmission line. At a receiving end, the WDM signal light received is separated into individual optical signals by an optical demultiplexer, and transmitted data is reproduced according to each optical signal. Accordingly, by applying WDM, the transmission capacity in a single optical fiber can be increased according to the number of WDM channels.

An optical AWG (arrayed waveguide grating) is sometimes used as the optical multiplexer or the optical demultiplexer. The optical AWG is an optical device utilizing the interference of light propagating in many optical waveguides having different optical path lengths. Since the optical waveguides expand and contract according to temperature, the optical AWG necessarily has temperature dependence of wavelength characteristic. Accordingly, to stably operate the system adopting WDM, the temperature of the optical AWG used as the optical multiplexer or the optical demultiplexer must be controlled to be maintained at a constant temperature, and it is desirable to detect the abnormality of the temperature of the optical AWG in operating the system.

Further, at the receiving end for receiving the WDM signal light transmitted, it is desirable in operating the system to detect whether or not each optical signal of the WDM signal light is normally received or whether or not the wavelength channel of each optical signal coincides with the receiving channel of each optical receiver.

Accordingly, in the system to which such a desirable operating method is applied, various detecting circuits or the like are necessary and a complicated configuration is required to monitor these detecting circuits.

### SUMMARY OF THE INVENTION

It is therefore an object of the present invention to provide a system having a simple configuration which allows easy monitoring on abnormality detection or the like in applying WDM and also to provide a method of operating the system.

In accordance with an aspect of the present invention, there is provided a system including an optical demultiplexer for separating WDM signal light transmitted by an optical fiber transmission line into a plurality of optical signals; a plurality of optical receivers for respectively receiving the plurality of optical signals output from the optical demultiplexer; means for detecting the abnormality of the temperature of the optical demultiplexer; and means for lowering the level of the WDM signal light on the upstream side of the optical demultiplexer when the abnormality of the temperature of the optical demultiplexer is detected.

In accordance with another aspect of the present invention, there is provided a system including an optical demultiplexer for separating WDM signal light transmitted by an optical fiber transmission line into a plurality of optical signals; a plurality of optical receivers for respectively receiving the plurality of optical signals output from the optical demultiplexer; means for detecting the temperature of the optical demultiplexer; and means for transmitting a status signal indicating a condition on the temperature of the optical demultiplexer to the downstream side of the optical demultiplexer.

In accordance with a further aspect of the present invention, there is provided a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the system including means for detecting the abnormality of the temperature of the optical demultiplexer and means for cutting off the WDM signal light on the upstream side of the optical demultiplexer when the abnormality of the temperature of the optical demultiplexer is detected.

In accordance with a still further aspect of the present invention, there is provided a method of operating a system having a first terminal device, a second terminal device, and an optical fiber transmission line for connecting said first and second terminal devices, said first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the method including the steps of detecting the abnormality of the temperature of the optical demultiplexer and cutting off the WDM signal light on the upstream side of the optical demultiplexer when the abnormality of the temperature of the optical demultiplexer is detected.

In accordance with a still further aspect of the present invention, there is provided a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the system including means for detecting the abnormality of the temperature of the optical demultiplexer and means for lowering the level of the WDM signal light on the upstream side of the optical demultiplexer when the abnormality of the temperature of the optical demultiplexer is detected.

In accordance with a still further aspect of the present invention, there is provided a method of operating a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the method including the steps of detecting the abnormality of the temperature of the optical demultiplexer and lowering the level of the WDM signal light on the upstream side of the optical demultiplexer when the abnormality of the temperature of the optical demultiplexer is detected.

In accordance with a still further aspect of the present invention, there is provided a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the system including means for detecting the abnormality of the temperature of the optical demuitiplexer and means for transmitting a status signal indicating the presence or absence of the abnormality of the temperature of the optical demultiplexer to the downstream side of the optical demultiplexer.

In accordance with a still further aspect of the present invention, there is provided a method of operating a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the method including the steps of detecting the abnormality of the temperature of the optical demultiplexer and transmitting a status signal indicating the presence or absence of the abnormality of the temperature of the optical demultiplexer to the downstream side of the optical demultiplexer.

In accordance with a still further aspect of the present invention, there is provided a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the system including means for detecting the abnormality of the temperature of the optical demultiplexer and means for transmitting a status signal indicating that the temperature of the optical demultiplexer is abnormal to the downstream side of the optical demultiplexer.

In accordance with a still further aspect of the present invention, there is provided a method of operating a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the method including the steps of detecting the abnormality of the temperature of the optical demultiplexer and transmitting a status signal indicating that the temperature of the optical demultiplexer is abnormal to the downstream side of the optical demultiplexer.

In accordance with a still further aspect of the present invention, there is provided a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the system including means for detecting the abnormality of the temperature of the optical demultiplexer and means for transmitting a status signal indicating that the temperature of the optical demultiplexer is normal to the downstream side of the optical demultiplexer.

In accordance with a still further aspect of the present invention, there is provided a method of operating a system having a first terminal device, a second terminal device, and an optical fiber transmission line for connecting the first and second terminal devices, the first terminal device including a plurality of optical transmitters for respectively outputting a plurality of optical signals and an optical multiplexer for wavelength division multiplexing the optical signals output from the optical transmitters to obtain WDM signal light, the second terminal device including an optical demultiplexer for separating the WDM signal light transmitted by the optical fiber transmission line into a plurality of optical signals and a plurality of optical receivers for respectively receiving the optical signals output from the optical demultiplexer, the method including the steps of detecting the abnormality of the temperature of the optical demultiplexer and transmitting a status signal indicating that the temperature of the optical demultiplexer is normal to the downstream side of the optical demultiplexer.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a block diagram showing a system to which the present invention is applicable;

FIG. 2 is a schematic diagram for illustrating the configuration and operation of an AWG unit usable as an optical multiplexer or an optical demultiplexer;

FIGS. 3, 4, and 5 are schematic views for illustrating different alarm conditions in optical receivers;

FIG. 6 is a schematic diagram for illustrating a method of transmitting the abnormality of the temperature of the AWG unit to the downstream side thereof;

FIG. 7 is a block diagram showing a first preferred embodiment of the system according to the present invention;

FIG. 8 is a time chart showing the operation of the system shown in FIG. 7;

FIG. 9 is a block diagram showing a second preferred embodiment of the system according to the present invention;

FIGS. 10A and 10B are block diagrams showing specific examples of the preferred embodiment shown in FIG. 9;

FIG. 11 is a time chart showing the operation of the system shown in FIG. 9;

FIG. 12 is a block diagram showing a third preferred embodiment of the system according to the present invention;

FIG. 13 is a block diagram showing a fourth preferred embodiment of the system according to the present invention;

FIGS. 14A and 14B are block diagrams showing specific examples of the preferred embodiment shown in FIG. 13;

FIG. 15 is a block diagram showing a fifth preferred embodiment of the system according to the present invention in the condition where an alarm is issued;

FIG. 16 is a block diagram similar to FIG. 15 in the condition where no alarm is issued;

FIG. 17 is a time chart showing the operation of the system shown in FIGS. 15 and 16;

FIG. 18 is a block diagram showing a sixth preferred embodiment of the system according to the present invention in the condition where no alarm is issued;

FIG. 19 is a block diagram similar to FIG. 18 in the condition where an alarm is issued;

FIG. 20 is a time chart showing the operation of the system shown in FIGS. 18 and 19;

FIG. 21 is a block diagram showing a seventh preferred embodiment of the system according to the present invention in the condition where an alarm is issued;

FIG. 22 is a block diagram similar to FIG. 21 in the condition where no alarm is issued;

FIG. 23 is a schematic diagram for illustrating the course of coincidence of the wavelengths allocated to channel ports of the AWG unit and the wavelengths of optical signals;

FIG. 24 is a time chart for illustrating a problem in the case that the reception of a status signal is insufficient;

FIG. 25 is a time chart for illustrating a problem in the case that time is required for the detection of the status signal;

FIG. 26 is a time chart for illustrating a method for solving the problem illustrated in FIG. 25;

FIG. 27 is a block diagram showing an eighth preferred embodiment of the system according to the present invention; and

FIG. 28 is a block diagram showing a ninth preferred embodiment of the system according to the present invention.

### DESCRIPTION OF THE PREFERRED EMBODIMENTS

Some preferred embodiments of the present invention will now be described in detail.

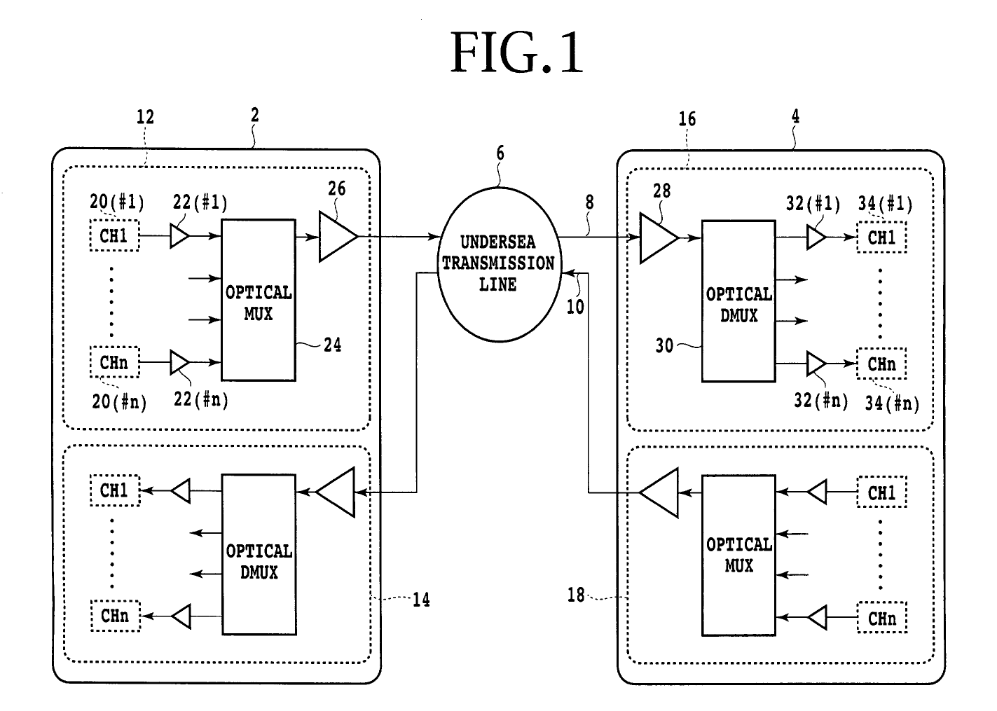

FIG. 1 is a block diagram showing a system to which the present invention is applicable.

This system is configured by installing an undersea transmission line 6 between terminal devices 2 and 4. The undersea transmission line 6 includes an optical fiber transmission line 8 for a downstream line extending from the terminal device 2 to the terminal device 4 and an optical fiber transmission line 10 for an upstream line extending from the terminal device 4 to the terminal device 2.

The terminal device 2 includes a transmitting section 12 for sending WDM signal light to the optical fiber transmission line 8 and a receiving section 14 for receiving WDM signal light transmitted by the optical fiber transmission line 10. The terminal device 4 includes a receiving section 16 for receiving WDM signal light transmitted by the optical fiber transmission line 8 and a transmitting section 18 for sending WDM signal light to the optical fiber transmission line 10. The transmitting section 18 and the receiving section 14 have the same configurations as those of the transmitting section 12 and the receiving section 16, respectively, so the configurations and operations of only the transmitting section 12 and the receiving section 16 will now be described.

The transmitting section 12 includes a plurality of optical transmitters 20(#1) to 20(#n) for respectively outputting a plurality of optical signals having different wavelengths, a plurality of optical amplifiers 22(#1) to 22(#n) for respectively amplifying the optical signals output from the optical transmitters 20(#1) to 20(#n), an optical multiplexer (MUX) 24 for wavelength division multiplexing the optical signals amplified by the optical amplifiers 22(#1) to 22(#n) to output resultant WDM signal light, and an optical amplifier 26 for amplifying the WDM signal light output from the optical multiplexer 24. The WDM signal light amplified by the optical amplifier 26 is sent to the optical fiber transmission line 8.

The receiving section 16 includes an optical amplifier 28 for amplifying the WDM signal light transmitted by the optical fiber transmission line 8, an optical demultiplexer (DMUX) 30 for separating the WDM signal light amplified by the optical amplifier 28 into a plurality of optical signals having different wavelengths, a plurality of optical amplifiers 32(#1) to 32(#n) for respectively amplifying the optical signals output from the optical demultiplexer 30, and a plurality of optical receivers 34(#1) to 34(#n) for respectively receiving the optical signals amplified by the optical amplifiers 32(#1) to 32(#n).

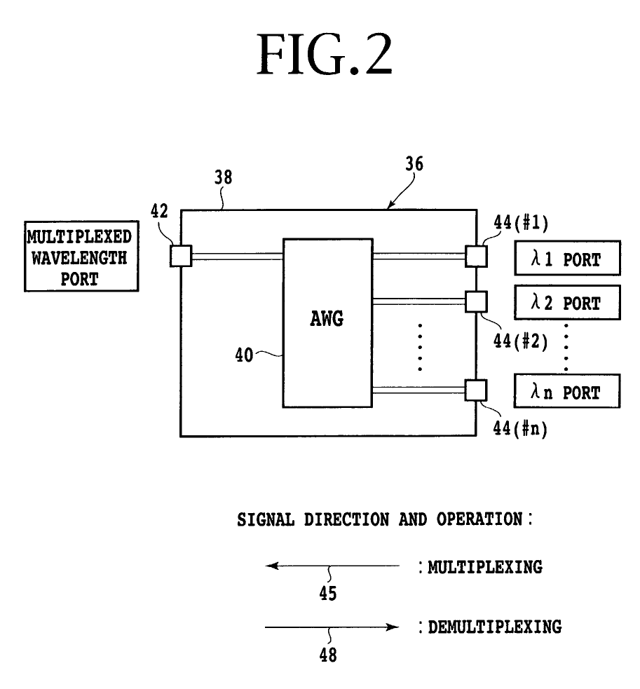

Referring to FIG. 2, there is shown an AWG (arrayed waveguide grating) unit 36 usable as each of the optical multiplexer 24 and the optical demultiplexer 30 shown in FIG. 1. The AWG unit 36 is configured by providing an AWG element 40 on a substrate 38. In the AWG element 40, a multiplexed wavelength port 42 and a plurality of individual wavelength ports 44(#1) to 44(#n) are optically connected. The multiplexed wavelength port 42 and the individual wavelength ports 44(#1) to 44(#n) are optically coupled by different wavelengths λ1 to λn. Accordingly, in a direction from the individual wavelength ports 44(#1) to 44(#n) to the multiplexed wavelength port 42, optical multiplexing of a plurality of optical signals into WDM signal light is allowed as shown by an arrow 46, whereas in a direction from the multiplexed wavelength port 42 to the individual wavelength ports 44(#1) to 44(#n), optical demultiplexing of WDM signal light into a plurality of optical signals is allowed as shown by an arrow 48.

Although not shown, a temperature control element such as a Peltier element is provided on the substrate 38 to control the temperature of the AWG element 40 to a constant temperature, and a control circuit for controlling and driving the temperature control element is additionally provided.

In the case of using the AWG unit 36 required to be controlled in temperature as mentioned above, the wavelength characteristic of the AWG unit 36 deviates if the temperature of the AWG unit 36 does not coincide with a target temperature, causing various problems. For example, at starting the system (cold starting), some time is required until the temperature of the AWG unit 36 becomes a target value after powering on the system, and in the case that various alarms are therefore set in the system, the operation of the system may be complicated or difficult. This will now be described more specifically.

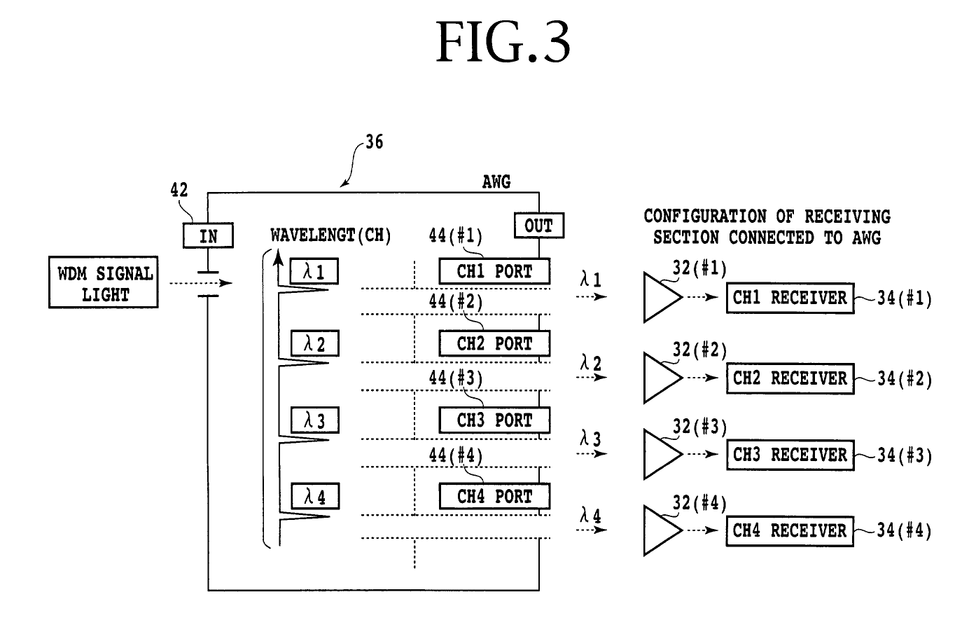

FIG. 3 shows a normal condition where the temperature of the AWG unit 36 coincides with a target value. In this case, it is assumed that n=4 and WDM signal light obtained by wavelength division multiplexing four optical signals having different wavelengths λ1 to λ4 is input into the AWG unit 36.

In the case that the temperature of the AWG unit 36 is controlled to become stable, the individual wavelength ports 44(#1) to 44(#4) output the optical signals having the wavelengths λ1 to λ4, respectively. In this case, the AWG unit 36 is used as the optical demultiplexer 30 (see FIG. 1). In such a normal condition, no alarm is issued from each of the optical receivers 34(#1) to 34(#4).

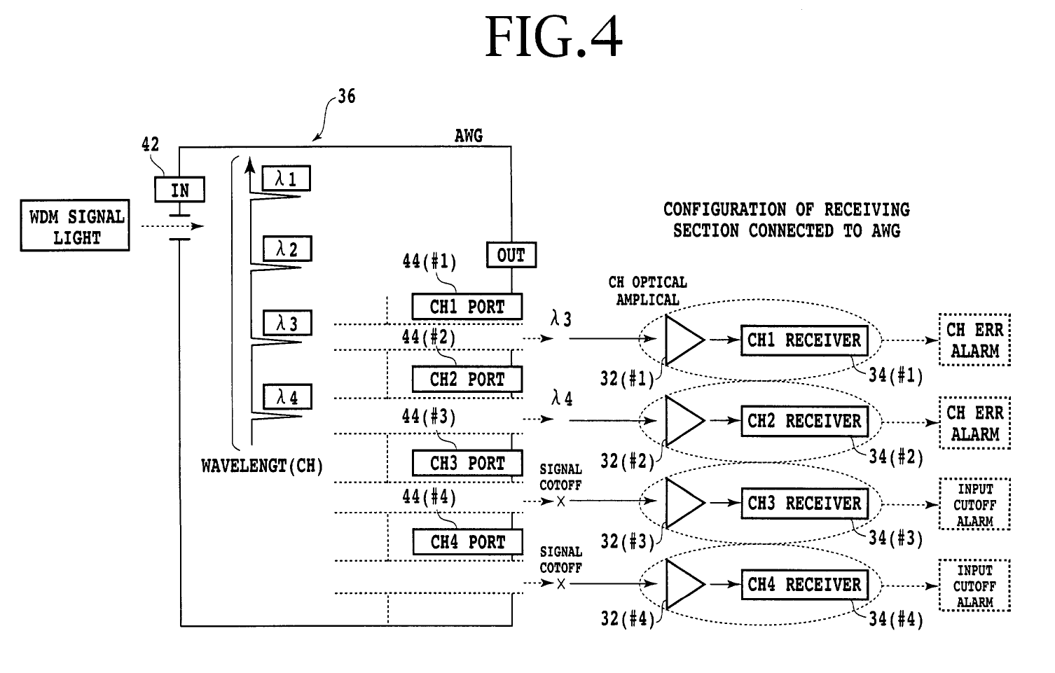

In the middle of temperature control as shown in FIG. 4, a condition that the optical signals having the wavelengths λ3 and λ4 respectively correspond to the individual wavelength ports 44(#1) and 44(#2), for example, may be assumed. In this case, the optical receivers 34(#1) and 34(#2) issue channel error alarms indicating deviations in wavelength channel, and the optical receivers 34(#3) and 34(#4) issue input cutoff alarms indicating that the input of the optical signals has been cut off.

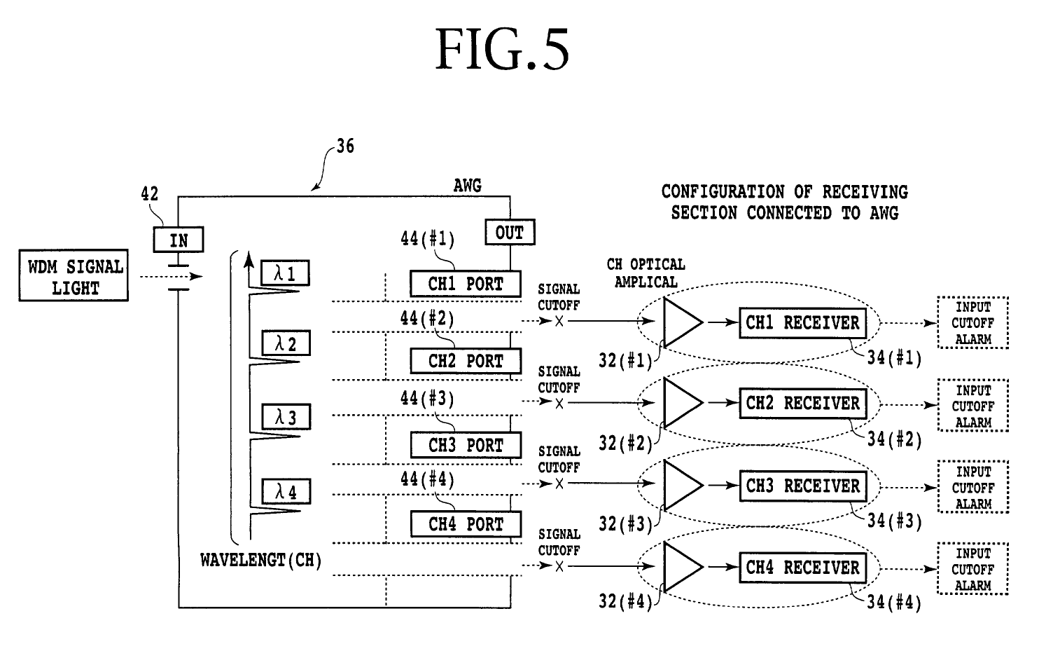

Further, in the middle of temperature control or in a transient period of temperature control as shown in FIG. 5, there is a possibility that none of the optical signals having the wavelengths λ1 to λ4 may correspond to the individual wavelength ports 44(#1) to 44(#4). In this case, input cutoff alarms are issued from all of the optical receivers 34(#1) to 34(#4).

The AWG unit 36 alternately has the conditions shown in FIGS. 4 and 5 and thereafter reaches the stable condition shown in FIG. 3. At starting the system, the alarm generally continues to be unstable for a considerable time period (in minutes) with varying degrees according to ambient temperature or the like until the temperature of the AWG unit 36 becomes stable. Further, the temperature control is automatically performed by the control circuit in the AWG unit 36 as mentioned above. Accordingly, the alarm condition is spontaneously restored to the normal condition, causing a possibility of confusion in operating the system.

Accordingly, it is desirable to fix a signal condition (e.g., signal cutoff) to avoid the transition of the alarm condition or to send the information that the AWG unit 36 is in temperature control (temperature abnormality alarm) to the devices downstream of the AWG unit 36, for the purpose of effectively and stably operating the system.

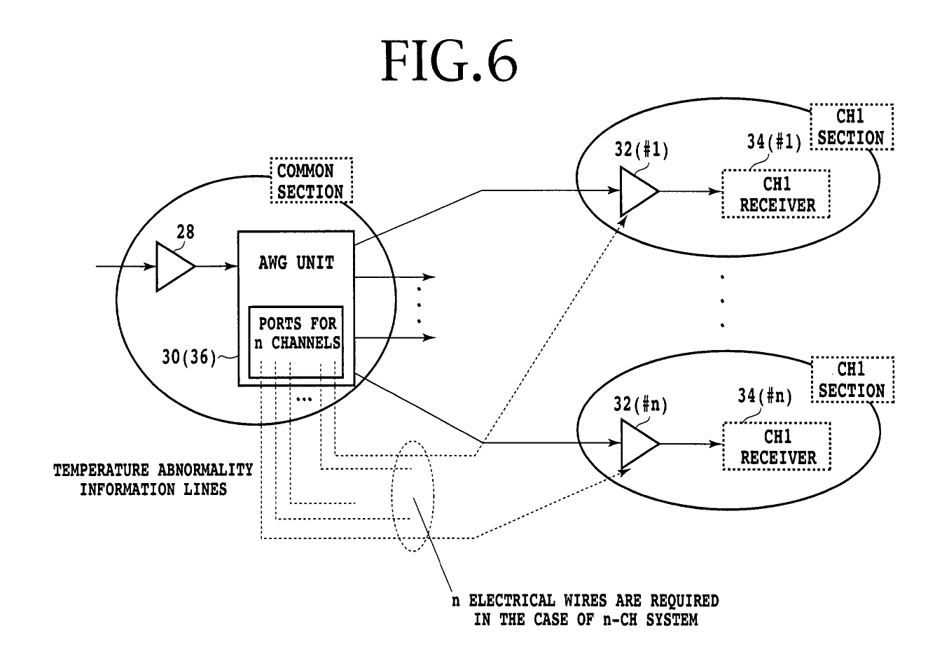

For example, in the case of electrically sending the temperature abnormality alarm to the downstream devices in the n-channel system as shown in FIG. 6, n electrical wires are respectively required for the n channels on the downstream side of the AWG unit 36. As a result, a space required for installation of the electrical wires is increased with an increase in number of the channels, causing a problem that the downstream devices become large in scale.

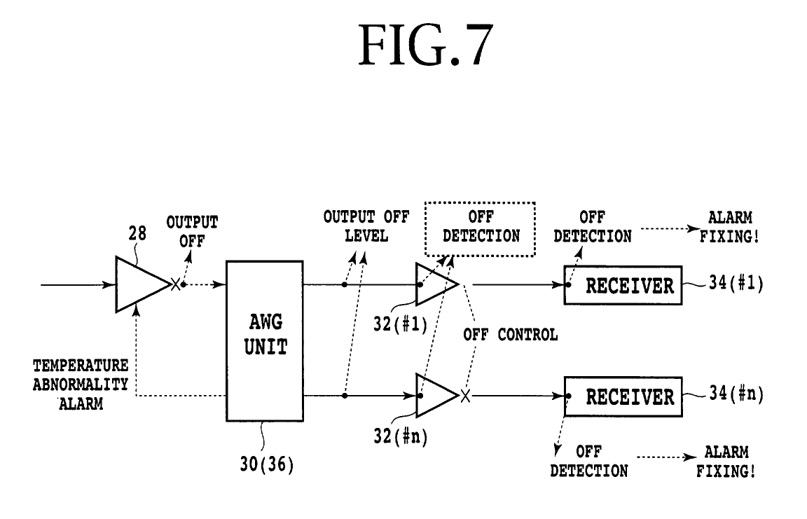

FIG. 7 is a block diagram showing a first preferred embodiment of the system according to the present invention. In this preferred embodiment, the abnormality of the temperature of the AWG unit 36 as the optical demultiplexer 30 is detected, and the WDM signal light is cut off on the upstream side of the AWG unit 36 when the temperature abnormality is detected. This will now be described more specifically.

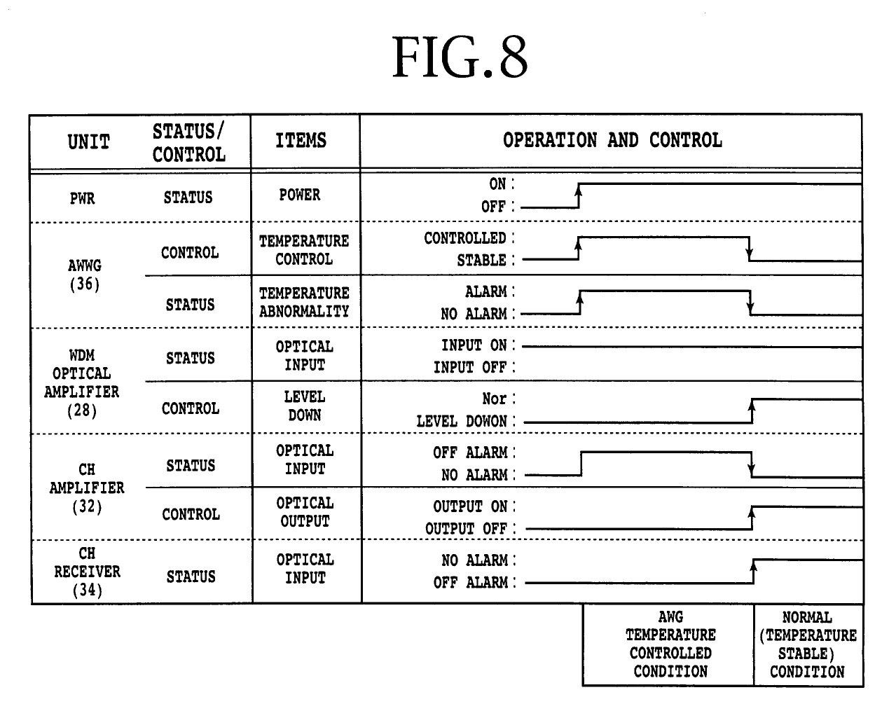

FIG. 8 shows the details of status/control of the power (PWR), the AWG unit 36, the optical amplifier 28, each optical amplifier 32, and each optical receiver 34. When the abnormality of the temperature of the AWG unit 36 is detected, a temperature abnormality alarm signal is supplied from the AWG unit 36 to the optical amplifier 28 for amplifying the WDM signal light. The optical amplifier 28 receives the temperature abnormality alarm signal and is controlled so as to cut off the output therefrom. In the case that the optical amplifier 28 includes an EDF (erbium doped fiber) and a pumping source for supplying pump light to the EDF, the output from the optical amplifier 28 can be cut off by reducing or nullifying the power of the pump light, for example.

At this time, the level of each optical signal output from the AWG unit 36 becomes an off level. As a result, the off level of the input to each optical amplifier 32 for amplifying the optical signal of each channel is detected, and each optical amplifier 32 is accordingly controlled so as to cut off the output therefrom.

As a result, the off level of the input to each optical receiver 34 is detected, and the alarm of such cutoff detection indicating the off level of the input to each optical receiver 34 is fixed.

When the control becomes stable so that the temperature of the AWG unit 36 coincides with a target value, the above operation is reversely performed to cancel the alarm in each optical receiver 34.

According to this preferred embodiment, the alarm indicating that the input to each optical receiver 34 has become off is issued in the temperature control of the AWG unit 36, so that there is no possibility of confusion in operating the system. Further, in each optical amplifier 32 and each optical receiver 34, the off level of the input is detected and suitable measures are taken. Accordingly, it is not required to provide excess signal lines for sending the information that the AWG unit 36 is in temperature control to the downstream devices.

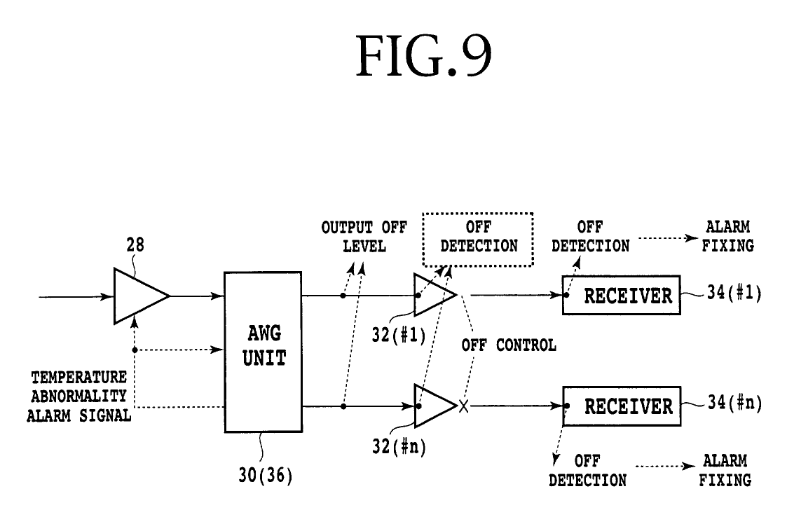

FIG. 9 is a block diagram showing a second preferred embodiment of the system according to the present invention. In contrast to the first preferred embodiment shown in FIG. 7 wherein when the abnormality of the temperature of the AWG unit 36 is detected, the optical amplifier 28 is controlled to cut off the WDM signal light on the upstream side of the AWG unit 36, the second preferred embodiment is characterized in that the level of the WDM signal light is forcibly lowered inside or outside of the optical amplifier 28 or the AWG unit 36.

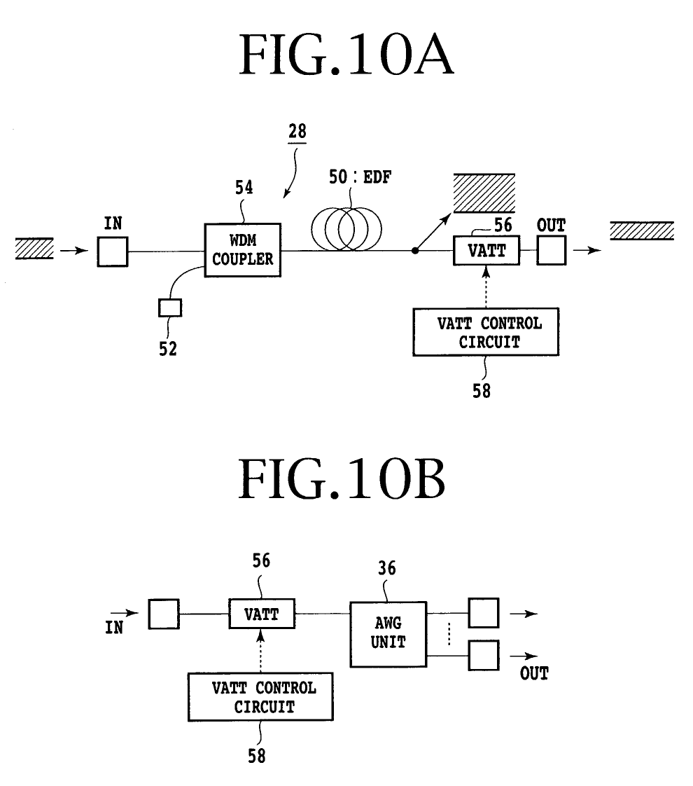

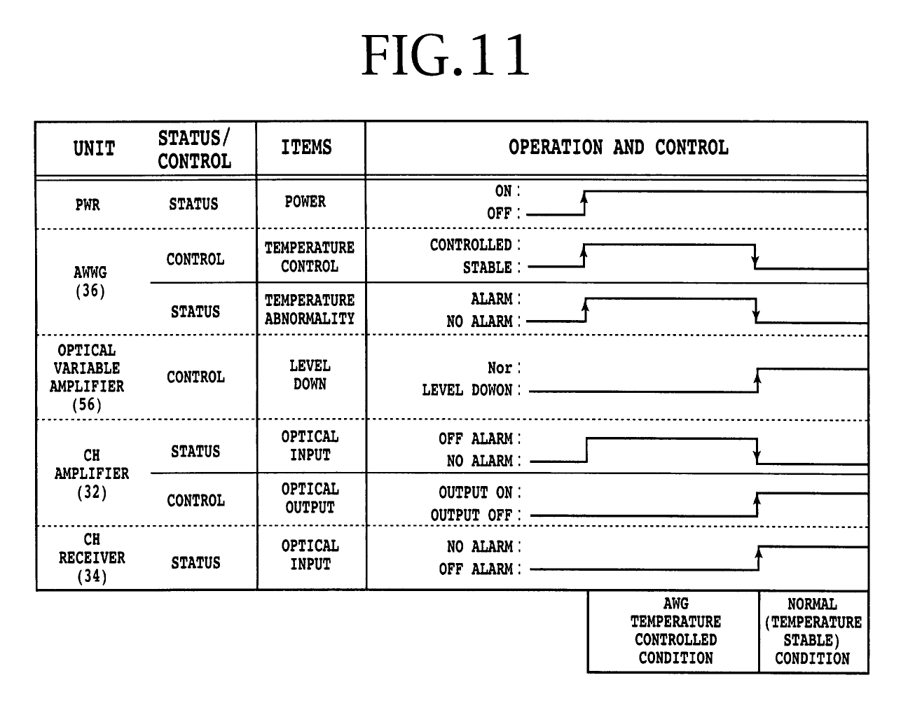

Specific examples of the second preferred embodiment are shown in FIGS. 10A and 10B. As shown in each of FIGS. 10A and 10B, an optical variable attenuator (VATT) 56 is inserted in the propagation path of the WDM signal light, and a VATT control circuit 58 is additionally connected to the optical variable attenuator 56.

In the example shown in FIG. 10A, the optical variable attenuator 56 is inserted in the optical path between an input port and an output port of the optical amplifier 28. The optical amplifier 28 includes an EDF 50 as an optical amplifying medium provided between the input port and the output port, a pumping source 52 for supplying pump light to the EDF 50, and a WDM coupler 54 for combining the pump light and the WDM signal light to be amplified. In this example, the optical variable attenuator 56 is interposed between the EDF 50 and the output port, and the WDM coupler 54 is interposed between the EDF 50 and the input port. Accordingly, the temperature abnormality alarm signal from the AWG unit 36 (see FIG. 9) is supplied to the VATT control circuit 58 in the optical amplifier 28 in this preferred embodiment.

In the example shown in FIG. 10B, the optical variable attenuator 56 is inserted on the input side of the AWG unit 36. Accordingly, the temperature abnormality alarm signal from the AWG unit 36 is supplied to the VATT control circuit 58 in relation to the AWG unit 36.

The second preferred embodiment shown in FIG. 9 including the specific examples shown in FIGS. 10A and 10B can also obtain effects similar to those of the first preferred embodiment shown in FIG. 7 by using the optical variable attenuator 56 to forcibly lower the level of the WDM signal light on the upstream side of the AWG unit 36 when the abnormality of the temperature of the AWG unit 36 is detected.

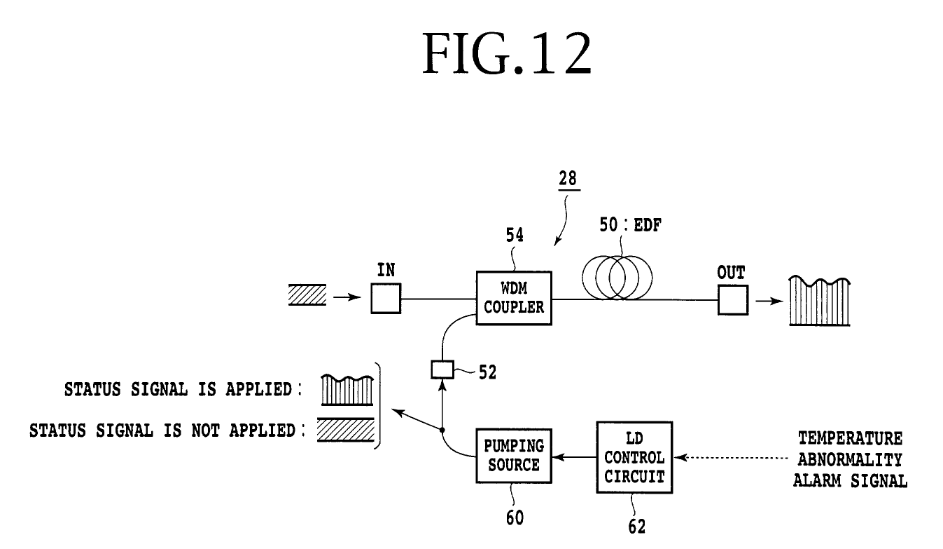

FIG. 12 is a block diagram showing a third preferred embodiment of the system according to the present invention. In this preferred embodiment, the abnormality of the temperature of the optical multiplexer 24 or the optical demultiplexer 30 (see FIG. 1) is detected, and a status signal indicating the presence or absence of the temperature abnormality detected is sent to the downstream side of the optical multiplexer 24 or the optical demultiplexer 30.

More specifically, this method is applied to the optical demultiplexer 30 at the receiving end in this preferred embodiment. That is, the gain of the optical amplifier 28 (see FIG. 1) is modulated according to the status signal. The status signal may be obtained as a burst signal of 10 to 100 bits, for example, according to the temperature abnormality alarm signal from the optical demultiplexer 30.

The status signal is supplied to an LD control circuit 62. The LD control circuit 62 applies a drive current to a pumping source 60 including an LD (laser diode) as a light source. The drive current is modulated according to the status signal to thereby modulate the power of pump light to be output from the pumping source 60. The pump light is supplied through a WDM coupler 54 to an EDF 50 as an optical amplifying medium. Accordingly, the pumping condition of the EDF 50 is modulated to thereby intensity-modulate the WDM signal light propagating in the EDF 50. As a result, a main signal (WDM signal light) with superimposition of the status signal is obtained.

The bit rate or speed of the status signal is set lower or smaller than the bit rate or speed of the main signal in the WDM signal light.

According to this preferred embodiment, the status signal can be easily regenerated by providing a decoder for decoding the status signal in each optical amplifier 32 or each optical receiver 34 at the receiving end. Accordingly, the abnormality of the temperature of the optical multiplexer 24 or the optical demultiplexer 30 can be acknowledged on the downstream side thereof without adding excess electrical wires or the like.

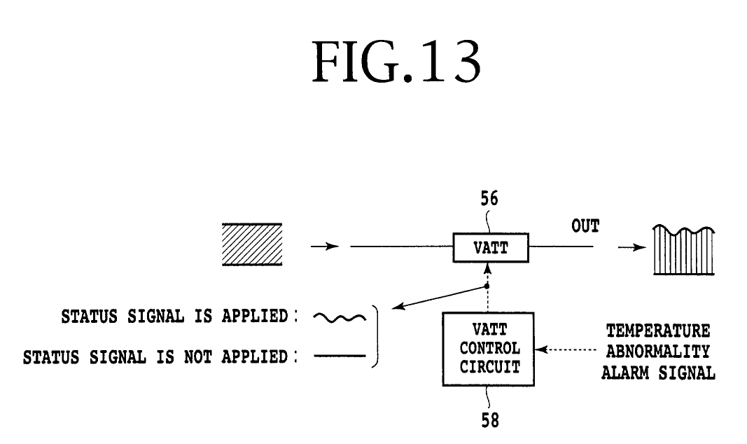

FIG. 13 is a block diagram showing a fourth preferred embodiment of the system according to the present invention. In contrast to the third preferred embodiment shown in FIG. 12 wherein the gain of the optical amplifier 28 is modulated according to the status signal, the fourth preferred embodiment shown in FIG. 13 is characterized in that the attenuation of an optical variable attenuator 56 is changed according to the status signal.

The optical variable attenuator 56 may be provided in the propagation path of the WDM signal light. For example, the attenuation of an optical attenuator configured by combining a Faraday rotator and a polarizer is changed according to a Faraday rotation angle.

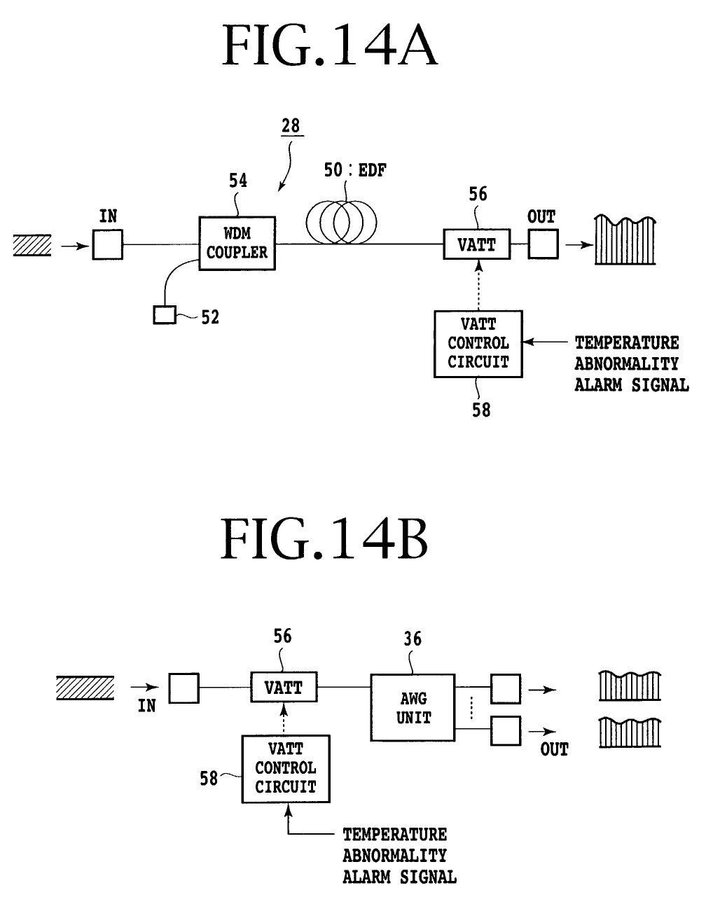

Specific examples of the fourth preferred embodiment shown in FIG. 13 applied to the optical demultiplexer 30 at the receiving end will now be described with reference to FIGS. 14A and 14B.

The position of the optical variable attenuator 56 shown in FIG. 14A is similar to that shown in FIG. 10A, and the position of the optical variable attenuator 56 shown in FIG. 14B is similar to that shown in FIG. 10B.

In the example shown in FIG. 14A, the attenuation of the optical variable attenuator 56 is changed by the status signal obtained according to the temperature abnormality alarm signal from the optical demultiplexer 30, and the status signal is superimposed on the WDM signal light amplified in the EDF 50.

In the example shown in FIG. 14B, the attenuation of the optical variable attenuator 56 is similarly changed by the status signal obtained according to the temperature abnormality alarm signal from the optical demultiplexer 30, and the status signal is superimposed on the WDM signal light to be supplied to the AWG unit 36. As a result, the same status signal is superimposed on each optical signal output from the AWG unit 36.

The fourth preferred embodiment shown in FIG. 13 including the specific examples shown in FIGS. 14A and 14B can also obtain effects similar to those of the third preferred embodiment shown in FIG. 12.

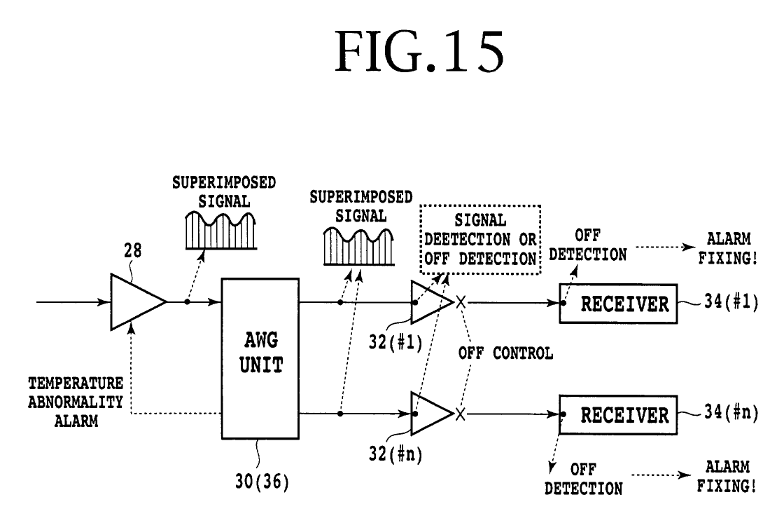

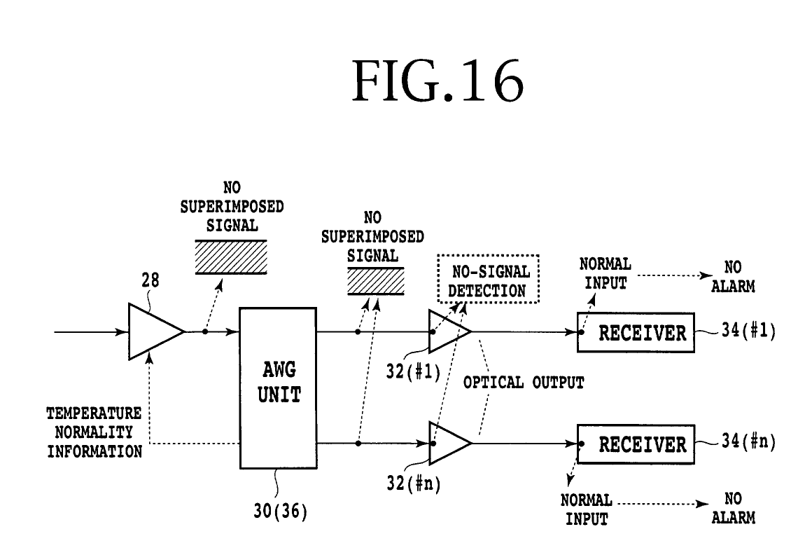

FIGS. 15 and 16 are block diagrams showing a fifth preferred embodiment of the system according to the present invention. In this preferred embodiment, the abnormality of the temperature of the AWG unit 36 used as the optical demultiplexer 30 is detected, and a status signal indicating that the temperature abnormality has been detected is sent to the downstream side of the AWG unit 36. In contrast to the previous preferred embodiment wherein the status signal is preferably a digital signal coded, a simple analog signal having a constant frequency may be used as the status signal in the fifth preferred embodiment shown in FIGS. 15 and 16.

When the abnormality of the temperature of the AWG unit 36 is detected as shown in FIG. 15, a temperature abnormality alarm is supplied from the AWG unit 36 to the optical amplifier 28. When the optical amplifier 28 receives the temperature abnormality alarm, the gain of the optical amplifier 28 is modulated by the status signal (e.g., simple analog signal having a constant frequency) as in the preferred embodiment shown in FIG. 12 and the status signal (superimposed signal) is superimposed on the WDM signal light to be supplied to the AWG unit 36. As a result, the same status signal is superimposed on each optical signal output from the AWG unit 36.

When each optical amplifier 32 detects the superimposition of the status signal according to each input optical signal, it is determined that the AWG unit 36 is in temperature control, and an alarm condition similar to that in the case that the input of each optical signal is cut off is fixed in each optical amplifier 32. At the same time, the output from each optical amplifier 32 is cut off.

By this control, an alarm can be fixed in each optical receiver 34 as in the first preferred embodiment shown in FIG. 7.

When the temperature of the AWG unit 36 coincides with a target temperature, temperature normality information is sent from the AWG unit 36 to the optical amplifier 28 as shown in FIG. 16, and the modulation of the gain of the optical amplifier 28 is then stopped according to this temperature normality information. Accordingly, the superimposition of the status signal on the WDM signal light output from the optical amplifier 28 is removed, and the operation of the components downstream of the AWG unit 36 is restored to the normal operation.

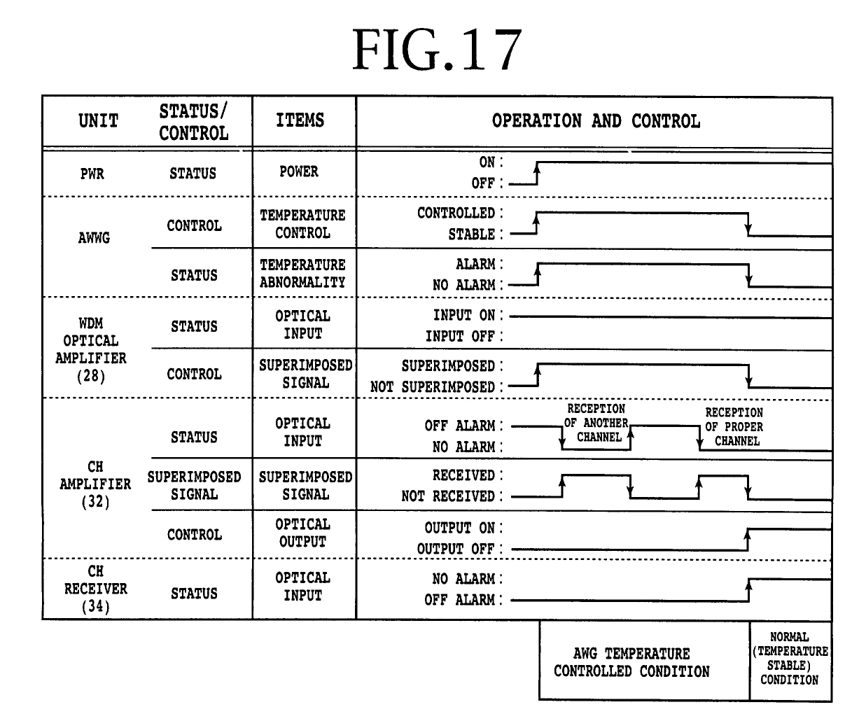

FIG. 17 shows the operation of the system in the preferred embodiment shown in FIGS. 15 and 16. According to this preferred embodiment, a malfunction occurring in the case of receiving any channels other than the properly allocated channel can be prevented by making the determination based on the presence or absence of the superimposition of the status signal prior to the other operations in the control to be performed in each optical amplifier 32.

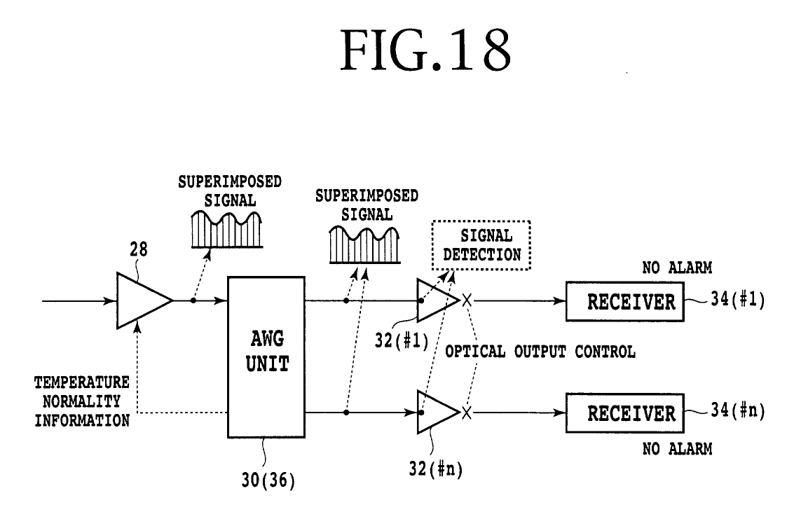

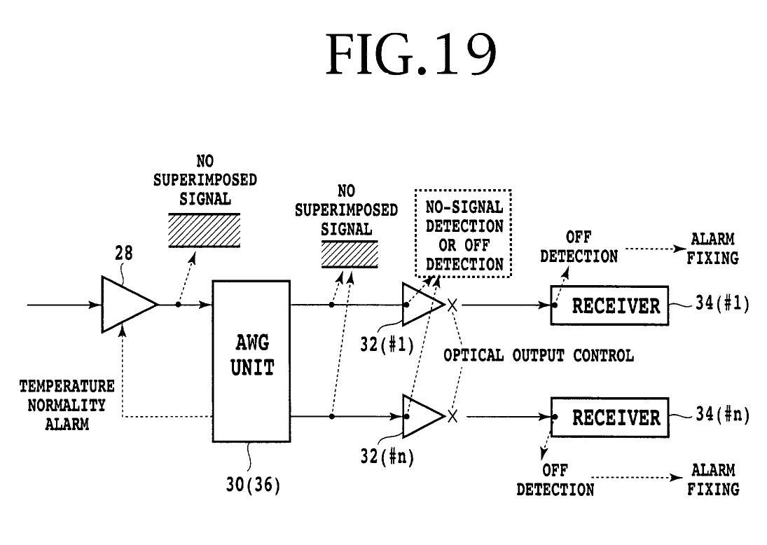

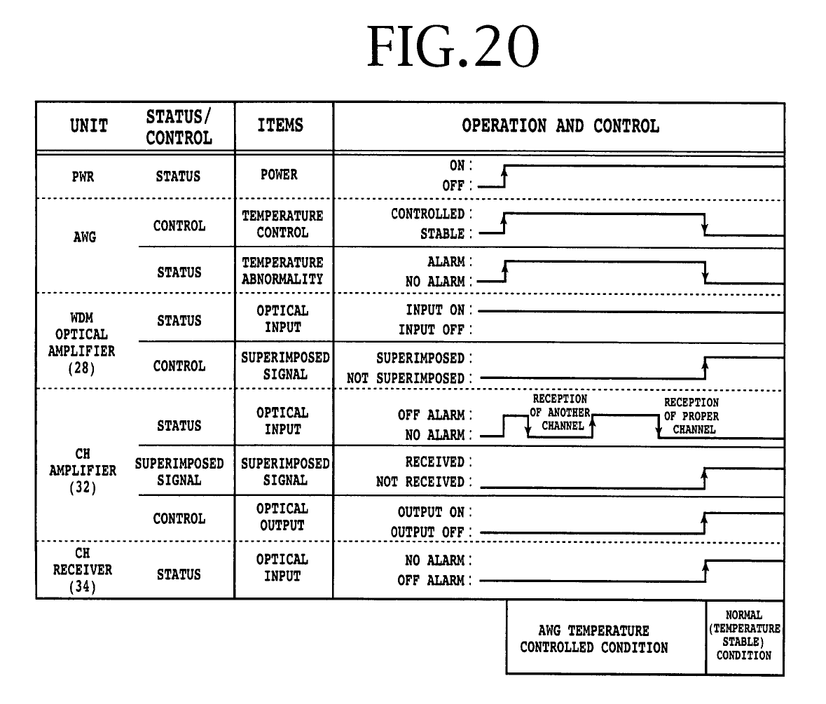

FIGS. 18 and 19 are block diagrams showing a sixth preferred embodiment of the system according to the present invention, and FIG. 20 is a time chart for illustrating the operation of the system in this preferred embodiment. The operation in this preferred embodiment is reverse to the operation in the preferred embodiment shown in FIGS. 15 to 17. That is, the abnormality of the temperature of the AWG unit 36 is detected, and a status signal indicating that the temperature abnormality is absent, i.e., the temperature of the AWG unit 36 is normal, as the result of this detection is sent to the downstream side of the AWG unit 36.

This preferred embodiment can also exhibit effects similar to those of the previous preferred embodiments.

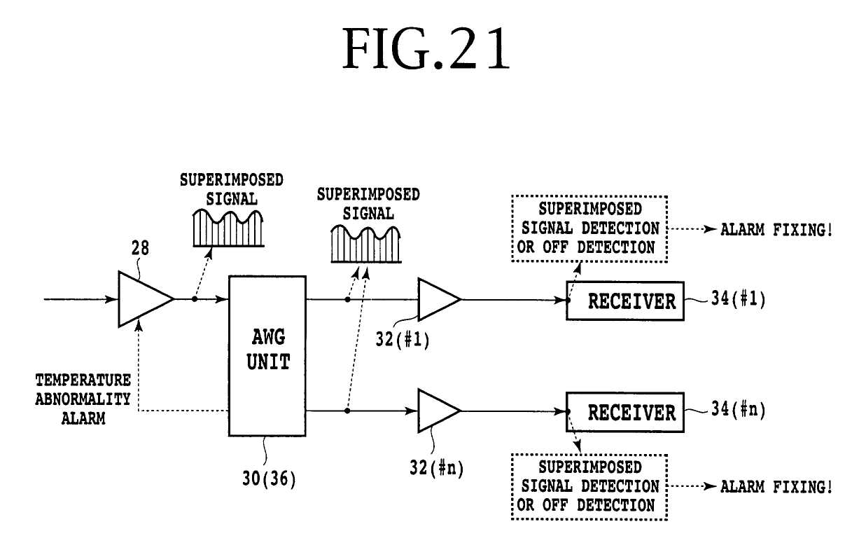

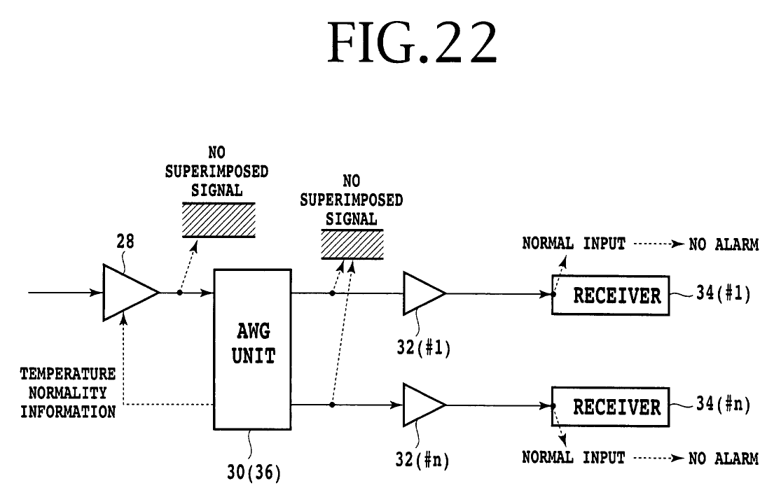

FIGS. 21 and 22 are block diagrams showing a seventh preferred embodiment of the system according to the present invention. In the preferred embodiment shown in FIG. 15, the condition that the input optical signal to each optical amplifier 32 is artificially cut off is realized according to the status signal in each optical amplifier 32 to follow the control in the preferred embodiment shown in FIG. 7. In contrast thereto, in the seventh preferred embodiment shown in FIGS. 21 and 22, each optical amplifier 32 does not have the above function, but each optical receiver 34 performs the control according to the status signal. That is, when each optical receiver 34 detects the status signal, the alarm in each optical receiver 34 is fixed.

The preferred embodiment shown in FIGS. 21 and 22 can also exhibit effects similar to those of the previous preferred embodiments.

In the course of coincidence of the wavelength allocated to each channel port of the AWG unit 36 and the corresponding wavelength of each optical signal, there is a transient period where the coincidence is imperfect. For example, in the transient period, there is a possibility that although an optical signal is received, the status signal cannot be received because the level of this optical signal is low.

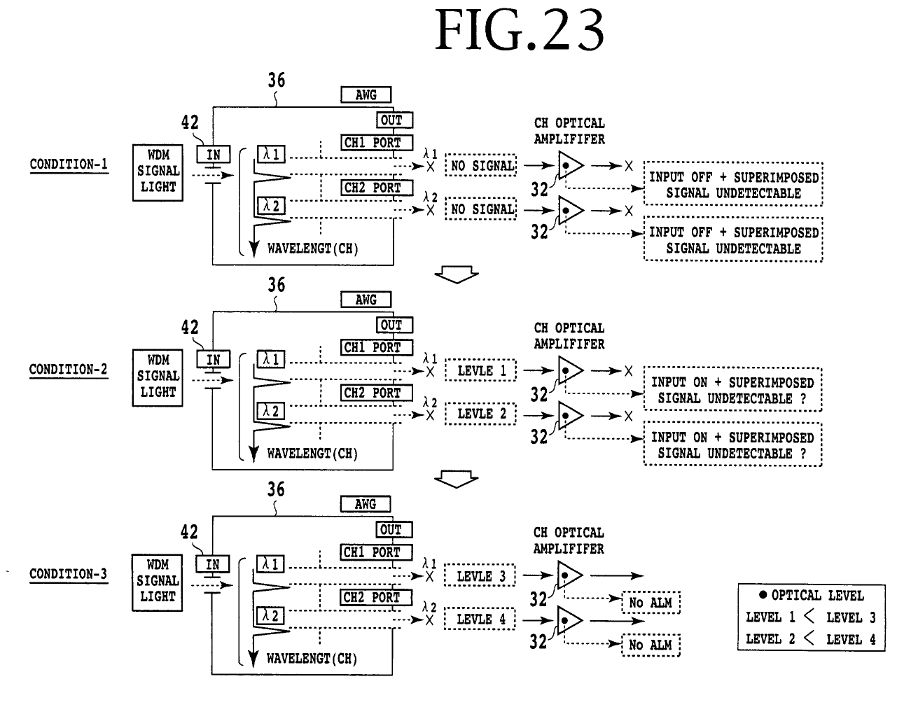

FIG. 23 illustrates such a transient period. In Condition-1 shown in FIG. 23, the wavelength of each channel port of the AWG unit 36 is completely deviated from the corresponding wavelength of each optical signal. Accordingly, each optical amplifier 32 does not input any optical signal and cannot therefore receive the status signal.

In Condition-2 shown in FIG. 23, the wavelength of each channel port of the AWG unit 36 is about to coincide with the corresponding wavelength of each optical signal. In this case, each optical amplifier 32 inputs the corresponding optical signal. However, there is a case that the status signal superimposed on the main signal cannot be detected.

In Condition-3 shown in FIG. 23, the wavelength of each channel port of the AWG unit 36 is in coincidence with the corresponding wavelength of each optical signal. In this case, no alarm is issued from each optical amplifier 32.

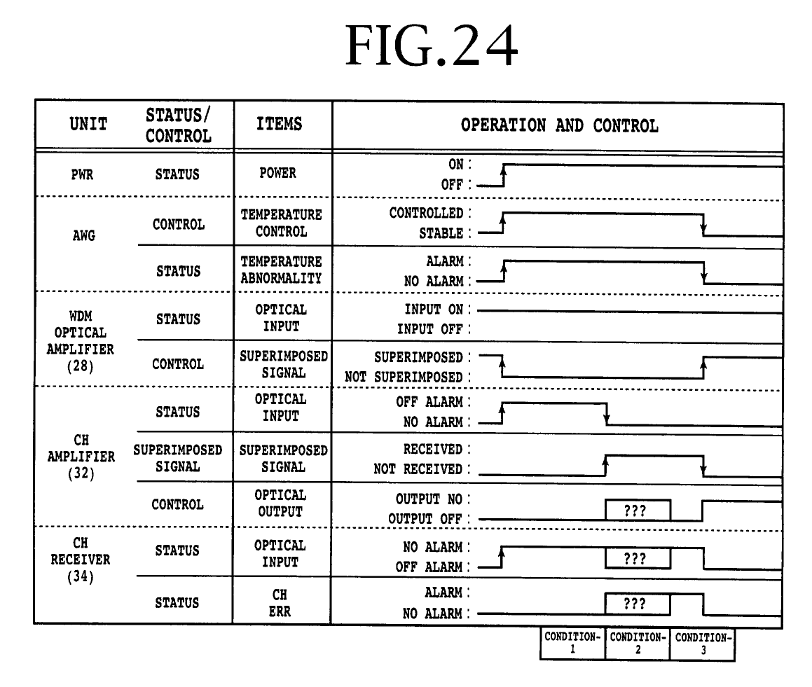

FIG. 24 shows a change of Condition-1 to Condition-3 shown in FIG. 23 with time. As indicated in FIG. 24, there is a possibility that the operations in each optical amplifier 32 and each optical receiver 34 may be unstable in Condition-2.

In the preferred embodiment shown in FIGS. 15 to 17, the superimposition of the status signal corresponds to the temperature abnormality. Accordingly, in consideration of the fact that the control for cutting off the output from each optical amplifier 32 is important, any means for this control is desired. For example, this means may be realized by maximizing the depth of modulation of the gain of the optical amplifier 28 by the status signal.

On the other hand, in the preferred embodiment shown in FIGS. 18 to 20, the superimposition of the status signal corresponds to the temperature stability. Accordingly, in consideration of the fact that the control for cutting off the optical signal from each optical amplifier 32 is important, no means for this control is required.

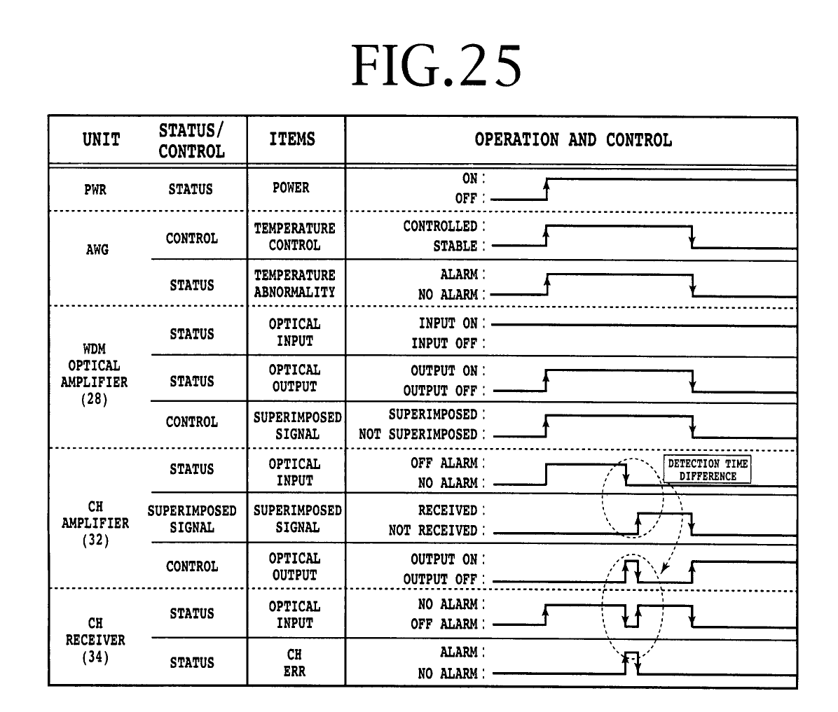

Further, if there is a time difference from the time when the cutoff of the input to each optical amplifier 32 is detected to the time when the status signal is detected as shown in FIG. 25, there is a possibility that the alarm condition on the downstream side of each optical amplifier 32 may be changed according to this time difference.

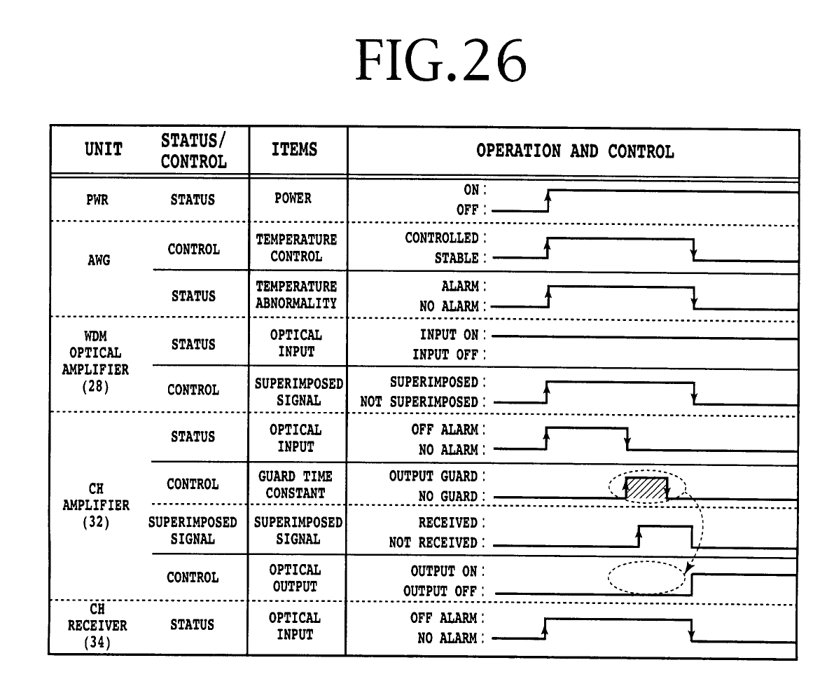

This possibility may be eliminated by providing a guard using a time constant for control in each optical amplifier 32 by a time period required for detection of the status signal as shown in FIG. 26. Accordingly, the superimposition of the status signal can be reliably confirmed, thereby allowing a stable operation of the system.

Finally, some specific preferred embodiments of the present invention applied to the transmitting end of the system will now be described.

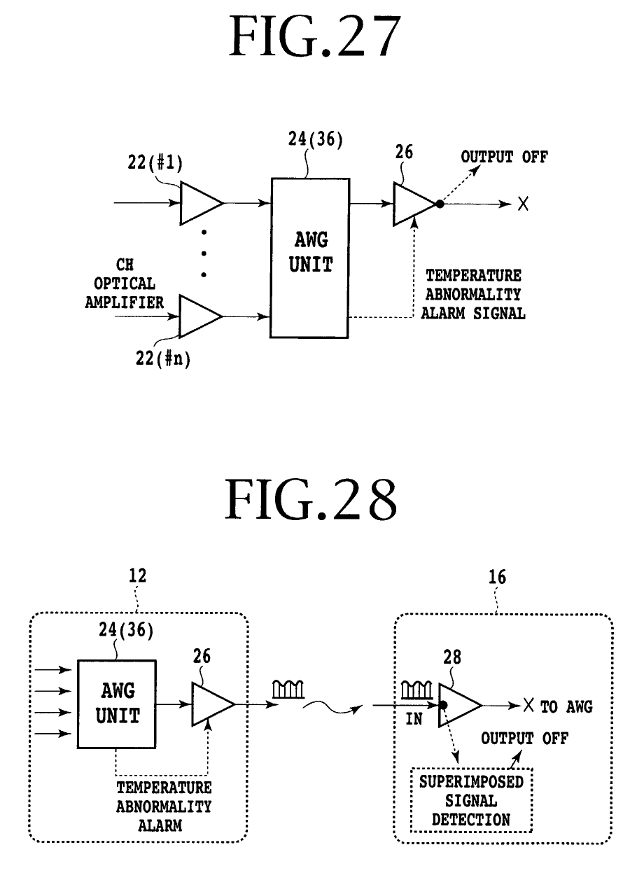

FIG. 27 is a block diagram showing an eighth preferred embodiment of the system according to the present invention. In this preferred embodiment, the abnormality of the temperature of the AWG unit 36 used as the optical multiplexer 24 at the transmitting end, and the optical amplifier 26 is controlled according to a temperature abnormality alarm signal resulting from the temperature abnormality detected. For example, by using an optical variable attenuator or an optical switch in the optical amplifier 26 or by cutting off pump light in the optical amplifier 26, the output from the optical amplifier 26 may be cut off when the temperature of the AWG unit 36 becomes abnormal. Accordingly, this preferred embodiment can also exhibit effects similar to those of the previous preferred embodiments.

FIG. 28 shows a ninth preferred embodiment of the system according to the present invention wherein a status signal is used at the transmitting end. In this preferred embodiment, when the abnormality of the temperature of the AWG unit 36 used as the optical multiplexer 24 is detected in the transmitting section 12, the status signal is superimposed in the optical amplifier 26. In the receiving section 16, the optical amplifier 28 detects the status signal received from the optical amplifier 26, thereby cutting off the output of the WDM signal light to the downstream device.

Thus, the present invention is not limitatively applicable to the case where an optical device whose characteristic changes with a temperature change is provided at the receiving end, but the present invention is also effective in the case that this kind of optical device is provided at the transmitting end. Further, the present invention is also applicable to the case where an optical device having temperature sensitivity is provided on the way of an optical fiber transmission line.

For example, known is an optical transmitter including a tunable laser used as a light source for signal transmission wherein the oscillation wavelength of the tunable laser is controlled by feedback control using a wavelength locker. In this kind of optical transmitter, the power and/or wavelength of an optical signal becomes unstable at starting the system, so that the application of the present invention to such an optical transmitter is effective. More specifically, by using an optical variable attenuator or an optical switch to apply the present invention, the output from the optical transmitter can be controlled to be off until the temperature or wavelength of the tunable laser becomes stable. Alternatively, by using a status signal according to the present invention, the information on temperature abnormality in the tunable laser can be transmitted to any device on the downstream side of the optical transmitter.

Further known is a dispersion compensator for use in an optical transmitter, an optical repeater, or an optical receiver, in which the dispersion compensator has a characteristic varying according to temperature. Also in this case, an effective operation of the system can be achieved by applying the present invention.

According to the present invention as described above, it is possible to provide a system having a simple configuration which allows easy monitoring on abnormality detection or the like in applying WDM, and also to provide a method of operating the system. Other effects obtained by the present invention have been described above, so the description thereof will be omitted herein.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A system comprising:
an optical demultiplexer for separating WDM signal light transmitted by an optical fiber transmission line into a plurality of optical signals;
a plurality of optical receivers for respectively receiving said plurality of optical signals output from said optical demultiplexer;
means for detecting the abnormality of the temperature of said optical demultiplexer; and
means for lowering the level of said WDM signal light on the upstream side of said optical demultiplexer when the abnormality of the temperature of said optical demultiplexer is detected.

2. A system according to claim 1, further comprising an optical amplifier connected to the input of said optical demultiplexer;
said lowering means comprising means for controlling pump light in said optical amplifier.

3. A system according to claim 1, further comprising a plurality of optical amplifiers respectively connected to the inputs of said plurality of optical receivers;
each of said optical amplifiers being controlled so that when an input to each optical amplifier is cut off, an output from each optical amplifier is cut off.

4. A system according to claim 1, wherein each of said optical receivers has means for issuing an alarm when said optical signal input to each optical receiver is cut off.

5. A system according to claim 1, further comprising an optical amplifier and an optical variable attenuator connected in series to the input of said optical demultiplexer;
said lowering means comprising means for maximizing the attenuation of said optical variable attenuator.

6. A system comprising:
an optical demultiplexer for separating WDM signal light transmitted by an optical fiber transmission line into a plurality of optical signals;
a plurality of optical receivers for respectively receiving said plurality of optical signals output from said optical demultiplexer;
means for detecting the temperature of said optical demultiplexer; and
means for transmitting a status signal indicating a condition on the temperature of said optical demultiplexer to the downstream side of said optical demultiplexer.

7. A system according to claim 6, wherein said transmitting means comprises means for superimposing said status signal on said WDM signal light.

8. A system according to claim 7, further comprising an optical amplifier connected to the input of said optical demultiplexer;
said superimposing means comprising means for modulating the power of pump light in said optical amplifier by said status signal.

9. A system according to claim 7, further comprising an optical variable attenuator connected to the input of said optical demultiplexer;
said superimposing means comprising means for changing the attenuation of said optical variable attenuator according to said status signal.

10. A system according to claim 6, further comprising a plurality of optical amplifiers respectively connected to the inputs of said plurality of optical receivers;
an output from each of said optical amplifiers being controlled according to said status signal.

11. A system according to claim 10, wherein each of said optical receivers has means for issuing an alarm according to said output from each optical amplifier.
